(19) United States
(12) Patent Application Publication
(10) Pub. No.: US 2005/0283275 A1
(43) Pub. Date: Dec. 22, 2005

(54) Method of teaching articulated robot and control equipment of articulated robot

(75) Inventors: Hideo Tokutake, Nagano-shi (JP); Tatsuo Niimura, Nagano-shi (JP)

Correspondence Address: JORDAN AND HAMBURG LLP, 122 EAST 42ND STREET, SUITE 4000, NEW YORK, NY, 10168, US

(73) Assignee: Kabushiki Kaisha Koyama, Nagano-shi (JP)

(21) Appl. No.: 10/870,196

(22) Filed: Jun. 17, 2004

(51) Int. Cl. G06F 19/00

(52) U.S. Cl. 700/264; 700/245

(57) ABSTRACT

The method of teaching an articulated robot is capable of rapidly and precisely teaching a moving track of the articulated robot. The method of teaching the articulated robot, in which a front end of the robot is moved to prescribed positions to teach the moving track, comprises the step of controlling motions of articulations of the robot so as to move the front end along axes of a coordinate system, wherein moving distances of the front end correspond to number of pulses inputted by a manual pulse generator.

### BACKGROUND OF THE INVENTION

The present invention relates to a method of teaching a moving track to an articulated robot having a plurality of articulations and a control equipment of the articulated robot.

Articulated robots are installed in factories. A front end of each articulated robot is moved to prescribed positions so as to automatically perform welding, grinding, abrading, assembling, transporting, etc.

To automatically and efficiently perform such works, an optimum moving track of the robot is previously inputted to the robot. This step is called “teaching”.

There are several conventional methods of teaching an articulated robot. For example, an operator manually moves the robot to prescribed positions to teach a moving track, the operator operates an operation panel so as to move the robot to the prescribed positions, or the front end of the robot is moved to the prescribed positions by inputting rotational angles of articulations of the robot.

In the conventional method of manually moving the robot, it is difficult to correctly move the front end to the prescribed positions with turning the articulations.

In the conventional method of operating the operation panel, the front end of the robot is approached to the prescribed positions by turning switches on and off many times. Therefore, it takes a long time to correctly move the front end to the prescribed positions, and it is difficult to precisely position the front end by the switches.

Further, in the conventional method of inputting the rotational angles of the articulations, the rotational angles of the articulations must be calculated so as to determine the position of the front end, so it takes a long time to calculate all data to be inputted.

These days, high positioning accuracy of the articulated robot is required, so teaching must be performed precisely. However, a plurality of the articulations simultaneously move, and motions of the articulations are complex. Therefore, it is impossible to rapidly and precisely teach the moving track by the conventional teaching methods.

### SUMMARY OF THE INVENTION

The present invention was invented to solve the above described disadvantages of the conventional teaching methods.

An object of the present invention is to provided a method of teaching an articulated robot, which is capable of rapidly and precisely teaching a moving track.

Another object of the present invention is to provide a control equipment of an articulated robot, which is capable of rapidly and precisely teaching a moving track.

To achieve the objects, the present invention has following structures.

Namely, the method of teaching the articulated robot, in which a front end of the robot is moved to prescribed positions to teach a moving track, comprises the step of:
controlling motions of articulations of the robot so as to move the front end along axes of a coordinate system,
wherein moving distances of the front end correspond to number of pulses inputted by a manual pulse generator.

With this method, an operator can teach the moving track by the manual pulse generator. Unlike the conventional method, the operator can rapidly and precisely teach the moving track without manually moving the robot and using switches to move the robot.

In the method, the coordinate system may be a rectangular coordinate system. In this case, the position of the front end can be easily understood, and the moving track can be easily defined. Therefore, the teaching can be further rapidly and precisely performed.

On the other hand, the control equipment of the articulated robot, which moves a front end of the robot to prescribed positions so as to teach a moving track, comprises:
a manual pulse generator having a manually-operated rotary dial, the manual pulse generator generating a pulse corresponding to a rotational angle of the rotary dial; and
control means for controlling motions of articulations of the robot so as to move the front end along axes of a coordinate system, wherein moving distances of the front end correspond to number of pulses inputted by the manual pulse generator.

With this structure, the operator can teach the moving track, by the manual pulse generator, on the basis of the pulse number. The operator can rapidly and precisely teach the moving track to the robot.

In the control equipment, the coordinate system may be a rectangular coordinate system. In this case, the position of the front end can be easily understood, and the moving track can be easily defined. Therefore, the teaching can be further rapidly and precisely performed.

The control equipment may further comprise a switch for selecting the axis of the coordinate system.

### BRIEF DESCRIPTION OF THE DRAWINGS

Embodiments of the present invention will now be described by way of examples and with reference to the accompanying drawings, in which:

FIG. 1 is an explanation view of arms of an articulated robot of an embodiment;

FIG. 2 is a block diagram of the articulated robot;

FIG. 3 is a front view of a manual pulse generator; and

FIG. 4 is an explanation view of teaching a moving track of the robot.

### DETAILED DESCRIPTION OF THE EMBODIMENTS

Preferred embodiments of the present invention will now be described in detail with reference to the accompanying drawings.

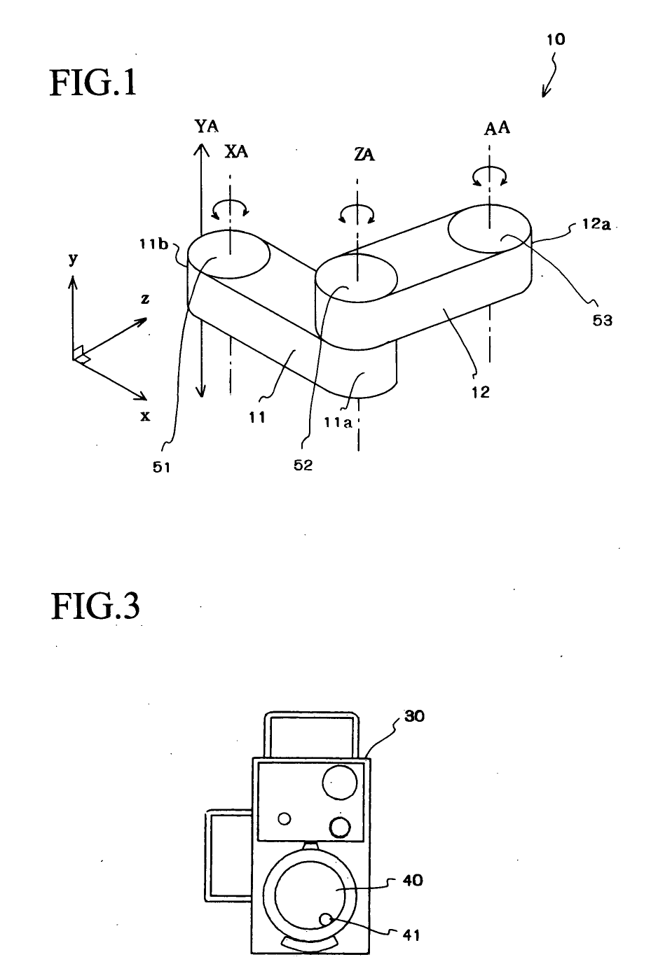

In an articulated robot 10 of an embodiment shown in FIG. 1, a couple of arms 11 and 12 have four axes: three rotation axes XA, ZA and AA and one linear motion axis YA. Rotary shafts 51, 52 and 53, which are respectively arranged in the directions of the axes XA, ZA and AA, constitute articulations.

The rotary shafts 51, 52 and 53 are arranged in the vertical direction; the arms 11 and 12 are turned in the horizontal plane. Therefore, the articulated robot 10 is a so-called horizontal type articulated robot.

The first arm 11 and the second arm 12 are pivotably connected by the rotary shaft 52.

In the robot 10, a rear end 11b of the first arm 11 is pivotably connected to a base (not shown) and capable of turning on the rotation axis ZA. Further, the first arm 11 is capable of vertically moving in the y-direction.

The rotary shaft 53 is provided to a front end 12a of the second arm 12. A manipulator for welding parts, grinding works, abrading works, assembling parts, transporting articles, etc. will be pivotably attached to the front end 12a.

Note that, in the present embodiment, an operator can move the robot 10 in a rectangular coordinate system including the horizontal axes x and z (an x-z plane) and the vertical axis y.

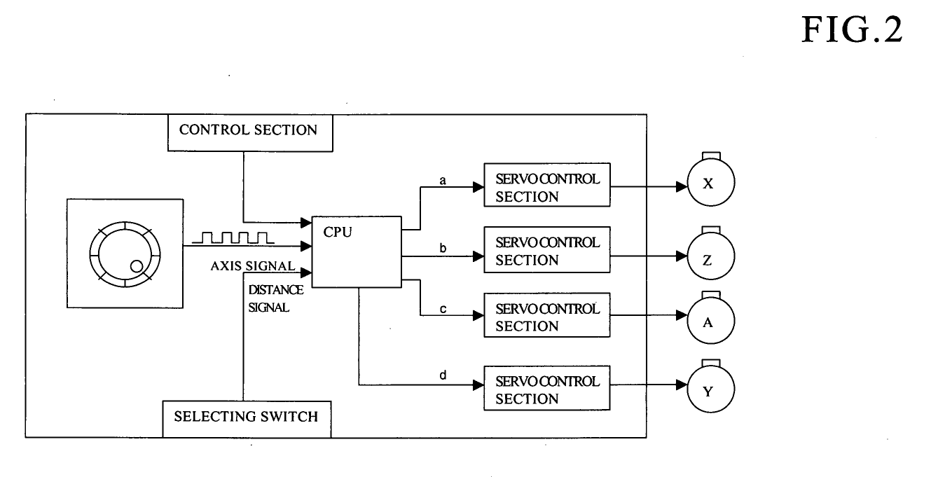

Means for driving the robot 10 and a control equipment will be explained with reference to FIG. 2.

The robot 10 has servo motors 22, 24 and 26, which respectively rotate the rotary shafts 51, 52 and 53. A servo motor 28 linearly moves the robot 10 in the direction of the linear motion axis YA.

The servo motor 22 is provided to the rear end 11b of the first arm 11, and an encoder 42 is provided to the motor 22. The encoder 42 detects a rotational position of the first arm 11 with respect to the base.

The servo motor 24 is provided to the articulation, which pivotably connects the arms 11 and 12, and an encoder 44 is provided to the motor 24. The encoder 44 detects a rotational position of the second arm 11 with respect to the front end 11a of the first arm 11.

The servo motor 26 is provided to the front end 12a of the second arm 12, and an encoder 46 is provided to the motor 26. The encoder 46 detects a rotational position of the manipulator, etc. (not shown) with respect to the front end 12a of the second arm 12.

Note that, an encoder 48 is provided to the servo motor 28, which vertically moves the robot 10 along the linear motion axis YA. The encoder 48 detects a height of the robot 10 with respect to a base position.

A control equipment 20 controls the servo motors 22, 24, 26 and 28, which are respectively provided to the rotary shafts 51, 52 and 53 and the base so as to teach a moving track of the front end 12a to the robot.

The control equipment 20 is usually separated away from the robot 10, so that an operator can control the robot 10 from a remote position.

The control equipment 20 includes: a control section 21; a manual pulse generator 30, which moves the robot 10 while teaching the moving track; a CPU 31; a selecting switch 33, which is used to select the moving direction or axis of the robot 10 from the axes x, y and z of the rectangular coordinate system; and servo control sections 32, 34, 36 and 38, which respectively servo-control the servo motors 22, 24, 26 and 28. The manual pulse generator 30 may be integrated with or separated from a housing of the control equipment 20 as far as the manual pulse generator 30 is electrically connected to the CPU 31.

The CPU 31 wholly controls the action of the robot 10. The CPU 31 outputs signals for controlling the servo motors 22, 24, 26 and 28.

The operator uses the control section 21 so as to control the robot 10 and perform the teaching action.

Successively, each element of the control equipment 20 will be explained.

A front view of the manual pulse generator 30 is shown in FIG. 3.

The manual pulse generator 30 has a rotary dial 40 and outputs prescribed number of pulses for each one turn of the rotary dial 40. There is provided a handle 41 for manually turning the dial 40 in a front face of the dial 40.

In the present embodiment, one turn of the dial 40 is divided into 100 divisions, so the manual pulse generator 30 generates 100 pulses when the operator turns the dial 40 once. The pulses are sent to the CPU 31.

If the operator turns the dial 40 fast, pulse separations are made short; if the operator turns the dial 40 slowly, pulse separations are made long. By changing the rotational speed of the dial 40, a moving speed of the robot 10 during the teaching action can be changed.

A characteristic of the present embodiment is to employ the manual pulse generator 30 so as to teach the moving track of the articulated robot, which is not directly operated in the rectangular coordinate system.

The pulses generated by the manual pulse generator 30, an axis signal indicating the axis selected by the selecting switch 33 and a distance signal indicating a moving distance of the front end 12a of the robot 10 are inputted to the CPU 31.

The CPU 31 selects the servo motors 22, 24, 26 and 28 on the basis of the inputted axis signal and sends control signals to the servo control section of the selected servo motor.

The operator can select the moving axis x, y or z, along which the robot 10 moves, by the selecting switch 33.

If the operator selects the x or y-axis, the robot 10 moves in the horizontal x-z plane. Therefore, the CPU 31 simultaneously controls the servo motors 22, 24 and 26.

On the other hand, if the operator selects the y-axis, the PU 31 controls the servo motors 28 only.

The action of the CPU 31 will be explained.

For example, if the operator selects the x-axis as the moving axis by the selecting switch 33 and one pulse is sent to the CPU 31 from the pulse generator 30, the CPU 31 calculates rotational angles of the servo motors 22, 24 and 26, which simultaneously turn the rotary shafts 51, 52 and 53 in the x-z plane, corresponding to one pulse.

Then, the CPU 31 outputs control signals a, b and c, which respectively indicate the calculated rotational angles of the motors 22, 24 and 26, so as to move the front end 12a the distance corresponding to one pulse.

On the other hand, if the operator selects the y-axis as the moving axis by the selecting switch 33 and a plurality of pulses are sent to the CPU 31 from the pulse generator 30, the CPU 31 calculates a rotational angle of the servo motor 28, which moves the robot 10 in the y-axis direction, corresponding to the pulse number.

Then, the CPU 31 outputs a control signal d, which indicates the calculated rotational angle of the motors 28, so as to move the front end 12a the distance corresponding to the pulse number.

Note that, the above described action of the CPU 31 is executed on the basis of control programs, which have been previously stored in a memory (not shown).

In the present embodiment, the actual moving distance of the front end 12a with respect to one pulse, which is generated by the pulse generator 30, can be determined by the selecting switch 33.

For example, one turn of the dial 40 is divided into 100 divisions, and the one division may be selectively corresponded to 0.1 mm, 0.01 mm or 0.001 mm.

The actual moving distance of the front end 12a corresponding to one division of the dial 40 can be selectively determined. Therefore, the actual moving distance with respect to one pulse can be smaller when the front end 12a is close to an object position, so that teaching the moving track can be rapidly and precisely performed.

The servo control sections 32, 34, 36 and 38 respectively include driver circuits receiving the control signals a, b, c and d.

As described above, the encoders 42, 44, 46 and 48, which are respectively provided to the motors 22, 24, 26 and 28, detect the rotational angles of the motors and send the detected angles to the CPU 31 and the servo control sections 32, 34, 36 and 38.

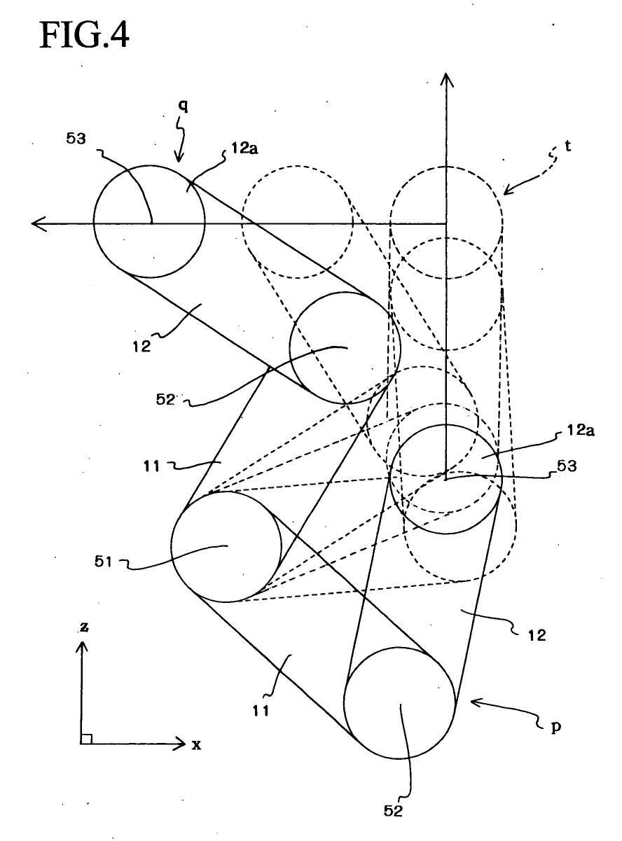

Successively, the method of teaching the moving track of the robot 10 will be explained with reference to FIG. 4.

In this example, the robot 10 will be moved from an initial position p, at which the robot 10 is shown by solid lines, to an object position q, at which the robot 10 is shown by solid lines.

Firstly, the operator selects a coordinate axis or axes, along which the robot 10 moves from the position p to the position q. In FIG. 4, the positions p and q are located in the horizontal plane, so the operator should move the front end 12a of the robot 10 along the x- and z-axes.

The operator selects the z-axis by the selecting switch 33 and moves the front end 12a along the z-axis.

Then, the operator determines the moving distance corresponding to one pulse, which is generated by the manual pulse generator 30, by the selecting switch 33.

By manually turning the dial 40 of the pulse generator 30, pulses, whose number corresponds to the rotational angle of the dial 40, are generated by the pulse generator 30 and inputted to the CPU 31.

The CPU 31 selects the servo motor or motors and calculates the rotational angle of the motor or motors on the basis of the axis signal and the distance signal, which are sent from the selecting switch 33, and the number of the pulses, which are generated by the pulse generator 30. In this example, the robot 10 will be moved along the z-axis, so the CPU 31 simultaneously drives the motors 22, 24 and 26.

The CPU 31 sends the control signals a, b and c to the servo control sections 32, 34 and 36. The servo control sections 32, 34 and 36 respectively supply electric currents, on the basis of the control signals a, b and c, to the motors 22, 24 and 26.

By supplying the electric currents to the motors 22, 24 and 26, the motors 22, 24 and 26 respectively turn the calculated angles.

As shown in FIG. 4, a distance in the z-axis direction between a mid position t and the object position q is zero. The operator manually operates the pulse generator 30 to move the front end 12a to the mid position t with visually monitoring the front end 12a.

By driving the motors 22, 24 and 26, the front end 12a of the robot 10 is moved from the initial position p to the mid position t. When the front end 12a is moved close to the mid position t, the operator changes the moving distance with respect to one pulse to a smaller value by the selecting switch 33. With this action, the front end 12a of the robot 10 can be precisely approached to the mid position t.

Next, the operator moves the front end 12a from the mid position t to the object position q.

Firstly, the operator selects the x-axis by the selecting switch 33 and moves the front end 12a along the x-axis. Then, the operator determines the moving distance corresponding to one pulse, which is generated by the manual pulse generator 30, by the selecting switch 33.

By manually turning the dial 40 of the pulse generator 30, pulses, whose number corresponds to the rotational angle of the dial 40, are generated by the pulse generator 30 and inputted to the CPU 31.

The CPU 31 selects the servo motor or motors and calculates the rotational angle of the motor or motors on the basis of the axis signal and the distance signal, which are sent from the selecting switch 33, and the number of the pulses, which are generated by the pulse generator 30. In this example, the robot 10 will be moved along the x-axis, so the CPU 31 simultaneously drives the motors 22, 24 and 26.

The CPU 31 sends the control signals a, b and c to the servo control sections 32, 34 and 36. The servo control sections 32, 34 and 36 respectively supply electric currents, on the basis of the control signals a, b and c, to the motors 22, 24 and 26.

By supplying the electric currents to the motors 22, 24 and 26, the motors 22, 24 and 26 respectively turn the calculated angles.

The operator manually operates the pulse generator 30 to move the front end 12a to the object position q with visually monitoring the front end 12a.

By driving the motors 22, 24 and 26, the front end 12a of the robot 10 is moved from the mid position t to the object position q. When the front end 12a is moved close to the object position q, the operator changes the moving distance with respect to one pulse to a smaller value by the selecting switch 33. With this action, the front end 12a of the robot 10 can be precisely approached to the object position q.

With this action, teaching the moving track from the initial position p to the object position q can be performed.

As described above, in the present embodiment, the rotary shafts 51, 52 and 53 are simultaneously turned; the robot 10 is moved in the direction of the axis YA without reference to the rotation of the rotary shafts 51, 52 and 53.

When pulses are sent from the manual pulse generator 30 to the CPU 31 so as to move the front end 12a in the x- or z-axis direction, the CPU 31 sends the control signals a, b and c to drive the motors 22, 24 and 26. The CPU 31 respectively assigns the rotational angles of the motors 22, 24 and 26, so that the front end 12a of the robot 10 is moved the distance corresponding to the pulse number. On the other hand, in the case of moving the front end 12a in the y-axis direction, the CPU 31 sends the control signal d to drive the motor 28 only. The CPU 31 assigns the rotational angle of the motor 28, so that the front end 12a of the robot 10 is moved the distance corresponding to the pulse number.

In the present embodiment, the articulated robot 10 has four axes XA, ZA AA and YA, but the present invention is not limited to the embodiment. Number of axes is not limited, so the articulated robot may have three axes, five axes, etc.

Further, the coordinate system, in which the articulated robot is moved, is not limited to the rectangular coordinate system.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of teaching an articulated robot, in which a front end of said robot is moved to prescribed positions to teach a moving track,
comprising the step of:
controlling motions of articulations of said robot so as to move the front end along axes of a coordinate system,
wherein moving distances of the front end correspond to number of pulses inputted by a manual pulse generator.

2. The method according to claim 1,
wherein the coordinate system is a rectangular coordinate system.

3. A control equipment of an articulated robot, which moves a front end of said robot to prescribed positions so as to teach a moving track,
comprising:
a manual pulse generator having a manually-operated rotary dial, said manual pulse generator generating a pulse corresponding to a rotational angle of the rotary dial; and
control means for controlling motions of articulations of said robot so as to move the front end along axes of a coordinate system, wherein moving distances of the front end correspond to number of pulses inputted by said manual pulse generator.

4. The control equipment according to claim 3,
further comprising a switch for selecting the axis of the coordinate system.

5. The control equipment according to claim 3,
wherein the coordinate system is a rectangular coordinate system.

6. The control equipment according to claim 5,
further comprising a switch for selecting the axis of the rectangular coordinate system.
